(19) United States
(12) Patent Application Publication
(10) Pub. No.: US 2010/0245244 A1
(43) Pub. Date: Sep. 30, 2010

(54) CHARACTER INPUTTING DEVICE

(76) Inventor: Eui Jin Oh, Daejeon (KR)

Correspondence Address: LEXYOUME IP GROUP, LLC, 5180 PARKSTONE DRIVE, SUITE 175, CHANTILLY, VA, 20151, US

(21) Appl. No.: 12/679,042

(22) PCT Filed: Sep. 22, 2008
(86) PCT No.: PCT/KR08/05624

§ 371 Date: Mar. 19, 2010

(30) Foreign Application Priority Data
Sep. 20, 2007 (KR) 10-2007-0095585

(51) Int. Cl. G06F 3/033

(52) U.S. Cl. 345/158

(57) ABSTRACT

The present invention relates to a character inputting device. The character inputting device includes an input unit, a detection unit, and a control unit. The input unit is configured such that a plurality of input areas is radially arranged around a reference location, one or more characters are assigned to each input area, and the respective characters can be selected through different input actions. The detection unit is configured to separately detect different input actions for each of the input areas. The control unit is configured to extract a relevant character from a memory unit in accordance with results of the detection by the detection unit, and input the character.

### TECHNICAL FIELD

The present invention relates, in general, to a character inputting device, and, more particularly, to a character inputting device, which has a small size and is thus applicable to various information devices and which can improve the precision of input actions and users' convenience.

### BACKGROUND ART

Alongside the development of semiconductor technology and information processing technology used in information devices, information devices are gradually becoming smaller and are becoming popularized, so that the importance of information processing and their application is gradually increasing. Accordingly, great efforts to provide an input device for rapidly and precisely inputting information have been made.

In order to input data at high speed, it is necessary to perform a so-called “one stroke-one phoneme” input, in which one phoneme (data) is input through one input action. When this one stroke-one phoneme input is applied to the Korean alphabet, it is necessary to arrange input keys for inputting 24 or more phonemes. When the target language of input is English, Japanese or some other language, or a combination thereof, a larger number of input keys must be arranged than in the case of the Korean alphabet.

As examples of such an input device, keyboards may be used. Such a keyboard is constructed in that a plurality of input keys used to select arbitrary data is provided, and data to be input is arranged on each of the input keys. Further, generally, two or more pieces of data in which the letters of the English alphabet and the Korean alphabet mingle together, are arranged on one input key. Since 100 or more input keys are generally provided as input keys, there is a limitation on the reduction in the size of the devices, such as notebook computers, that are carried and used, and thus it is difficult to reduce all information devices due to the input device size constraint.

As another input device, touch screen schemes used in Personal Data Assistants (PDAs) are inconvenient for users because the speed of input is slow and the incidence of erroneous input is high.

Furthermore, keypad schemes used in mobile phones are problematic in that, since 24 or more Korean alphabet letters are input using only 12 input keys due to the small size of mobile phones, it is inevitable to arrange a plurality of letters on each input key and to perform a repeated input action so as to input a single phoneme, so that the speed of input is decreased and the occurrence of erroneous actions is increased, thus increasing the user's inconvenience. Further, such a mobile phone is problematic in that, since numbers, letters of the English alphabet and various symbols, as well as letters of the Korean alphabet, must be used together, inconvenience attributable to a repeated input action is further increased, and a lot of time is required for input.

### DISCLOSURE OF INVENTION

### Technical Problem

Accordingly, the present invention has been made keeping in mind the above problems, and an object of the present invention is to provide a character inputting device, which minimizes erroneous input and the motion of a finger on the basis of directionality that can be easily grasped by anyone, thus enabling input to be performed faster.

Another object of the present invention is to provide a character inputting device, in which three characters can be input at the same location (a single input key) through different input actions, thus enabling a large amount of data to be input even using a small area, and which is applied to various information devices, thus realizing the light weight and small size of information devices.

### Technical Solution

In order to accomplish the above objects, the present invention provides a character inputting device, comprising an input unit configured such that a plurality of input areas is radially arranged around a reference location, one or more characters are assigned to each input area, and the respective characters can be selected through different input actions; a detection unit configured to separately detect different input actions for each of the input areas; and a control unit configured to extract a relevant character from a memory unit in accordance with results of the detection by the detection unit, and input the character.

Preferably, each input area may be configured such that a first character, a second character and a third character are assigned thereto, the first character is selected by touching the input area, the second character is selected by performing outward touch movement from the reference location towards an outside of the input area, and the third character is selected by performing inward touch movement from the outside of the input area towards the reference location.

Further, each input area may be configured such that a first character, a second character and a third character are assigned thereto, the first character is selected by touching the input area, the second character is selected by pressing the input area, and the third character is selected by performing outward touch movement from the reference location towards an outside of the input area.

In this case, one of the first character, the second character and the third character may be a vowel.

In this case, the first character is a consonant, the second character is a vowel, and the third character is a consonant. Alternatively, the first character is a first consonant, the second character is a second consonant, and the third character is a vowel.

Meanwhile, the input unit may be implemented as two units located on left and right sides so that they can be used by both hands.

Further, the input unit may be implemented as a ring-shaped integrated input unit.

Furthermore, the input unit may be implemented as a touch pad or a touch screen.

The character inputting device may further comprise at least one input key which is capable of performing one or more functions and is provided inside or outside the input unit.

Meanwhile, in each input area, characters which can be input are displayed, and action indication units required to distinguish respective input actions from each other are provided together with the displayed characters.

Further, when the input unit performs an input action of moving to a first input area in a circumferential direction and inputting a character assigned to the first input area, without terminating in nut for a second in nut area in a state in which the input for the second input area is performed, the control unit processes input by recognizing only the input for the second input area and the input for the first input area as effective inputs.

In addition, when the detection unit detects that two or more input actions have been continuously performed in the input unit, the control unit processes input by recognizing that characters corresponding to the respective input actions are input for respective input areas on which the input actions are performed.

### ADVANTAGEOUS EFFECTS

Accordingly the character inputting device of the present invention is advantageous in that, thanks to a simple construction and usage method based on directionality that can be easily grasped by anyone, convenient data input can be provided, and in that, since three characters can be arranged on a single input key and can be selectively input in accordance with a user's intention, a plurality of input actions can be performed in a limited area, so that the character inputting device is applicable to various information devices, thus realizing the light weight and small size of information devices.

Furthermore, the character inputting device of the present invention continuously performs touch input, pressing input, inward touch movement input, outward touch movement input and circumferential movement input, without releasing a single touch, thus enabling fast character input. Further, since the arrangement of characters is separated depending on respective inputs, and consonants and vowels are separated depending on the arrangement of characters, one action-multi-phoneme input is possible through one continuous action, thus enabling character input to be performed faster.

### BRIEF DESCRIPTION OF THE DRAWINGS

FIG. 1 is a perspective view showing a portable small-sized device equipped with a character inputting device according to the present invention;

FIG. 2 is a diagram showing the construction of a character inputting device according to the present invention;

FIG. 3 is a plan view showing an example of the shape of a detection unit according to the present invention;

FIG. 4 is a diagram showing the construction of a first embodiment of a character inputting device according to the present invention;

FIG. 5 is a diagram showing a detailed input action in the first embodiment;

FIG. 6 is a diagram showing a shape in which additional input keys are arranged in the first embodiment;

FIG. 7 is a diagram showing the construction of a second embodiment of a character inputting device according to the present invention; and

FIGS. 8 and 9 are diagrams showing input actions in the second embodiment.

### MODE FOR THE INVENTION

Hereinafter, embodiments of the present invention will be described in detail with reference to the attached drawings.

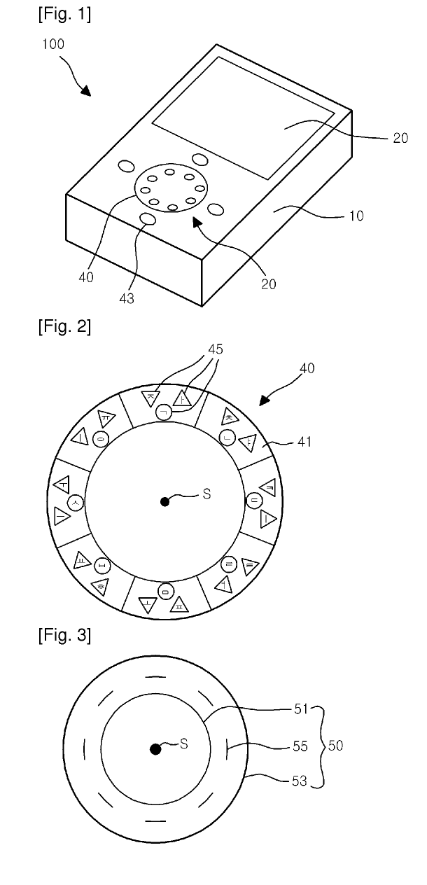

FIG. 1 is a perspective view showing a portable small-sized device equipped with a character inputting device according to the present invention, FIG. 2 is a diagram showing the construction of a character inputting device according to the present invention, and FIG. 3 is a plan view showing an example of the shape of a detection unit according to the present invention.

As shown in the drawings, the character inputting device of the present invention may be used in a portable small-sized device 100, for example, an electronic device such as a mobile phone or a Personal Digital Assistant (PDA). The portable small-sized device 100 is configured such that a display unit 20 and a character inputting device 30 according to the present invention are provided on a base 10 and input keys (not shown) for performing other input actions may be further provided thereon.

Further, in FIG. 1, the character inputting device 30 according to the present invention is provided on the base 10 separately from the display unit 20, but may be provided on the display unit 20. In this case, the display unit 20 is preferably manufactured using a material by which various input actions, performed by the character inputting device 30, for example, touch, pressing and touch movement, can be detected. As an example of the material, a touch screen may be used.

The above-described character inputting device 30 according to the present invention includes an input unit 40 in which a plurality of input areas 41 is radially arranged around a reference location S, one or more characters are assigned to each of the input areas 41, and the respective characters can be selected through different input actions, a detection unit 50 configured to separately detect different input actions for the input areas 41, and a control unit (not shown) configured to extract a relevant character from a memory unit (not shown) and to input the character in accordance with the results of the detection by the detection unit 50.

Here, the input areas 41 of the input unit 40 in the character inputting device 30 of the present invention may also be implemented using a touch pad or a touch screen, as well as typical pressing input keys.

Meanwhile, when the input unit 40 of the present invention has a structure in which input can be performed on the input areas 41 in the form of input keys, various input actions can be performed on the input keys using the fingers. However, when the input areas 41 are implemented as a touch pad or a touch screen, input actions can be performed using an input tool, such as a stylus pen, in addition to the fingers.

Further, the input unit 40 may be formed as a ring-shaped integrated type input unit, as described later with reference to subsequent embodiments, and may be formed as a unit in which respective input areas are spaced apart from each other and are independently provided.

Although not shown in the drawings, the input unit 40 may be formed as two input units on left and right sides so that they can be used by both hands. In this structure, the input unit 40 of the present invention is formed as two input units 40, so that the number of input signals that can be input using respective input areas 41 has been increased twofold, thus enabling more characters to be arranged. Further, it is also possible that two input units 40 are provided, and that the same number of characters are arranged in each of the two input units. In this case, each of the input units performs input in four directions.

In addition, input keys 42 and 43 capable of performing one or more functions may be further provided inside or outside the input unit 40 (refer to FIG. 6).

Meanwhile, in one input area 41, one or more characters are arranged and can be input through different input actions. For example, when three characters are arranged in the input area 41, three of touch input T, inward touch movement input I, outward touch movement input O, and pressing input P can be selected and can be assigned to the characters, respectively.

Here, the term “touch input T” means an input action of bringing a finger or an input tool into contact with the input area 41. Such touch input T is performed such that, even though the finger or input tool touches an arbitrary location on a relevant input area 41, a corresponding character is selected from the input area by a touch.

The term “pressing input P” means an input action of applying a pressure to the input area 41 using a finger or an input tool, and indicates an input action having a relatively high touch strength compared to that of touch input.

The term “inward touch movement input I” means an input action of performing touch movement from the outside of the input area 41 towards the reference location S. The inward touch movement input I can be similarly performed through an action of moving from the input area towards the reference location, an action of moving from the outside of the input area towards the reference location via the input area, or an action of moving from the outside of the input area towards the input area.

Further, the term “outward touch movement input O” means an input action of performing touch movement from the reference location S towards the outside of the input area 41. The outward touch movement input O may be similarly performed through an action of moving from the reference location towards the input area, an action of moving from the reference location towards the outside of the input area via the input area, or an action of moving from the input area towards the outside of the input area.

In the case where three characters are arranged in one input area 41, when they are classified as a first character, a second character and a third character, one of the first to third characters may be a vowel. In this case, the first character may be a consonant, the second character may be a vowel, and the third character may be a consonant. The first character may be a first consonant, the second character may be a second consonant, and the third character may be a vowel.

The arrangement of the characters may be determined depending on characters used in a language desired to be input by the character inputting device 30. That is, in the case of the English alphabet, consonants are divided into first characters and third characters and are arranged, and vowels are arranged as second characters. Further, in the case of a language such as Korean in which one character may be regarded as being derived from another character, fundamental consonants are set as first consonants and are arranged as first characters, consonants derived from the first consonants are set as second consonants and are arranged as second characters, and vowels are arranged as third characters.

However, it is apparent that such an arrangement is not absolute, and may be varied according to the characteristic of a relevant language. For example, when the number of second consonants derived from the first consonants is small, vowels as well as the second consonants may also be included in the second characters.

As described above, when characters are divided into consonants and vowels and are arranged to be input through three or more input actions, the continuity between touch and touch movement may be realized, thus enabling input to be performed faster. However, when it is difficult to divide characters into consonants and vowels due to the characteristics of the language of each country, first to third characters may be arranged in a form suitable for that language.

Meanwhile, action indication units 45, which enable input actions of inputting respective characters, that is, touch, pressing, inward touch movement and outward touch movement, to be distinguished from each other, are displayed together with the respective characters. Therefore, the user can input specific characters after checking input actions of inputting specific characters through corresponding action indication units 45.

That is, the action indication units 45 are configured such that, in order for the user to easily perform inward touch movement and outward touch movement on input keys, ‘inward touch movement’ is indicated by a symbol of Δ pointing towards the reference location S, and the outward touch movement is indicated by a symbol of Δ pointing towards the outside of the input keys. Further, the action indication units 45 are configured such that ‘touch’ is indicated by a symbol of ◯, and ‘pressing’ is indicated by a symbol of ⊚. Further, the action indication units 45 may be displayed using symbols or colors required to distinguish input directions from each other.

Further, as shown in FIG. 3, the detection unit 50 may include an inner detection line 51, a direction detection line 55 and an outer detection line 53 used to distinguish ‘inward touch movement’ from ‘outward touch movement’. The respective detection lines are preferably formed in the shapes of circular bands along the circumferential direction of the input areas 41. In this case, the direction detection line 55 is formed to correspond to eight radial directions from the reference location S, and is configured to detect the direction of a touch or a touch movement.

Detection signals obtained from the detection lines are generated when the direction detection line 55 is touched, when the inner detection line 51 and the outer detection line 53 are simultaneously touched together with the direction detection line 55, or when either one of the inner detection line 51 and the outer detection line 53 is detected together with the direction detection line 55 within a predetermined time.

At this time, in the case where the detection lines are simultaneously touched and are then released, the control unit recognizes this case as touch input T. In the case where sequential touch occurs in the direction from the reference location S to the outside in the sequence of the inner detection line 51→the direction detection line 55→the outer detection line 53, the control unit recognizes this case as outward touch movement input O. In contrast, in the case where sequential touch occurs in the direction from the outside to the reference location S in the sequence of the outer detection line 53→the direction detection line 55→the inner detection line 51, the control unit recognizes this case as inward touch movement input I.

In this case, the detection unit 50 may be an optical sensor, a capacitive sensor, a pressure sensor or a touch sensor, and the type thereof is not limited as long as the touch of a finger or an input tool such as a stylus pen can be detected. That is, the detection unit 50 can be provided in a structure capable of detecting a touch, as used in a typical touch pad or touch screen, in order to detect the touch of a finger or the movement of the touch. In this case, the detection unit 50 may further include a component for detecting the pressing of the finger, for example, a pressure sensor or the like.

### First Embodiment

Next, a first embodiment of the character inputting device according to the present invention will be described below.

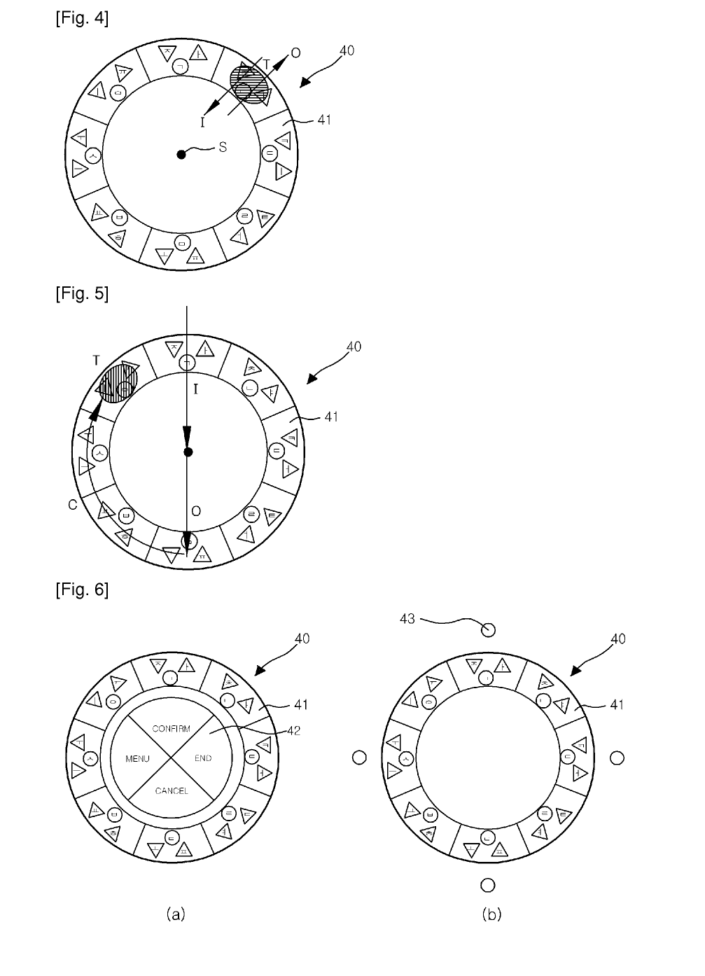

FIG. 4 is a diagram showing the construction of a first embodiment of a character inputting device according to the present invention, FIG. 5 is a diagram showing a detailed input action in the first embodiment, and FIG. 6 is a diagram showing a shape in which additional input keys are arranged in the first embodiment.

As shown in the drawings, in the present embodiment, touch input T, inward touch movement input I, and outward touch movement input O may be performed on each of the input areas 41. First characters may be input by a touch, second characters may be input through outward touch movement, and third characters may be input through inward touch movement.

In detail, in the input unit 40, [symbol] [symbol] [symbol] [symbol] [symbol] [symbol] [symbol] and [symbol] which are first consonants, are arranged as first characters and are selected by touching corresponding input areas 41. Further, in the input unit 40, [symbol] [symbol] [symbol] [symbol] [symbol] [symbol] [symbol] and [symbol] which are vowels, are arranged as second characters and are selected by performing outward touch movement on corresponding input areas 41. Further, [symbol] [symbol] [symbol] [symbol] [symbol] [symbol] [symbol] and [symbol] which are second consonants, are arranged as third characters and are selected by performing inward touch movement on corresponding input areas 41. Here, although [symbol] and [symbol] are not consonants, they may be included in the third characters to bring the number of third characters to 8.

Further, since the first characters can be input by a touch, an action indication unit 45 of ◯ indicating a touch is displayed together with each of the first characters. Since the second characters can be input through outward touch movement, an action indication unit 45 of Δ pointing towards the outside of the input areas is displayed together with each of the second characters to indicate outward touch movement. Furthermore, since the third characters can be input through inward touch movement, an action indication unit 45 of Δ pointing towards the inside of the input areas is displayed together with each of the third characters to indicate inward touch movement.

In the present embodiment as shown in FIG. 4, the input of a character is described with reference to FIG. 5.

For example, in order to input a character [symbol] inward touch movement input I is performed on an input area 41 located in the direction of 12 o'clock. Then, a third character [symbol] displayed the input area 41, located in the direction of 12 o'clock together with the action indication unit 45 indicating inward touch movement, is input. Next, outward touch movement input O is performed on an input area 41 located in the direction of 6 o'clock. Then, a vowel [symbol] that is, a second character displayed in the input area 41 located in the direction of 6 o'clock together with an action indication unit 45 indicating outward touch movement, is input. Further, when touch input T is performed on an input area 41 located in the direction of 11 o'clock, a first character [symbol] displayed in the input area 41 located in the direction of 11 o'clock together with the action indication unit 45 indicating a touch, is input, and thus the character [symbol] is completed.

In this case, after outward touch movement is performed on the input area 41 located in the direction of 6 o'clock, a touch is moved to the input area 41 located in the direction of 11 o'clock while moving in the circumferential direction. In this way, a touch is moved to pass through intervening input areas 41 located in the direction of 7 o'clock and 9 o'clock while moving in the circumferential direction. However, the circumferential movement of FIG. 5 does not stop at the intervening input areas 41 located in the direction of 7 o'clock and 9 o'clock, and a touch is performed on the input area 41 located in the direction of 11 o'clock, and thereafter input is released. Therefore, characters assigned to the intervening input areas 41 located in the direction of 7 o'clock and 9 o'clock are not input, but a character, assigned to the input action for the input area 41 which is located in the direction of 11 o'clock and is a final input location, is input. Therefore, in FIG. 5, after a touch on the input area 41 located in the direction of 11 o'clock has been performed, input is released and thus [symbol] corresponding to the touch input T is input. This input action is called circumferential touch movement input C.

Such circumferential touch movement input C can be implemented using various methods. That is, detection terminals capable of detecting the circumferential touch movement input C are arranged between the respective input areas 41, so that circumferential touch movement input C can be detected. Further, in the case where one detection signal is successively detected before another detection signal is released at the time of performing circumferential touch movement input C, this case may be detected as the circumferential touch movement input C.

Further, in the case where continuous touch movement is detected in the circumferential direction when input is performed on a touch pad or a touch screen, this case may be detected as the circumferential touch movement input C.

As described above, in the character inputting device 30 according to the present embodiment, characters can be input by manipulating respective input areas 41 through a one action-one phoneme input (touch, inward touch movement, and outward touch movement). However, when these actions are implemented as one action (touch+inward touch movement+outward touch movement), one action-multi-phoneme input is possible.

Further, in the character inputting device 30 according to the present embodiment, when two or more of touch input T, inward touch movement input I, outward touch movement input O, and circumferential touch movement input C are continuously detected as one input, the control unit can process the input by recognizing that the respective characters have been input.

Here, the term “one input” means that, after initial input is performed, subsequent inputs are successively performed at one time in the state in which the initial input is not terminated without separately performing two or more inputs.

Meanwhile, as shown in FIG. 6, a plurality of input keys 42 and 43 for enabling the input of characters or performing the functions of cancel, confirm, menu, etc., may be further provided inside or outside the input unit 40. This structure is described in detail. As shown in FIGS. 6(A) and 6(B), input keys 42 having additional pressing functions are located inside the input unit 40 formed as a ring-shaped integrated input unit. Further, four extension input keys 43 enabling a touch or pressing function are additionally provided outside the input unit 40. The extension input keys may be configured such that separate characters are arranged thereon or various types of functional commands may be performed thereby.

### Second Embodiment

Next, a second embodiment of a character inputting device according to the present invention will be described below.

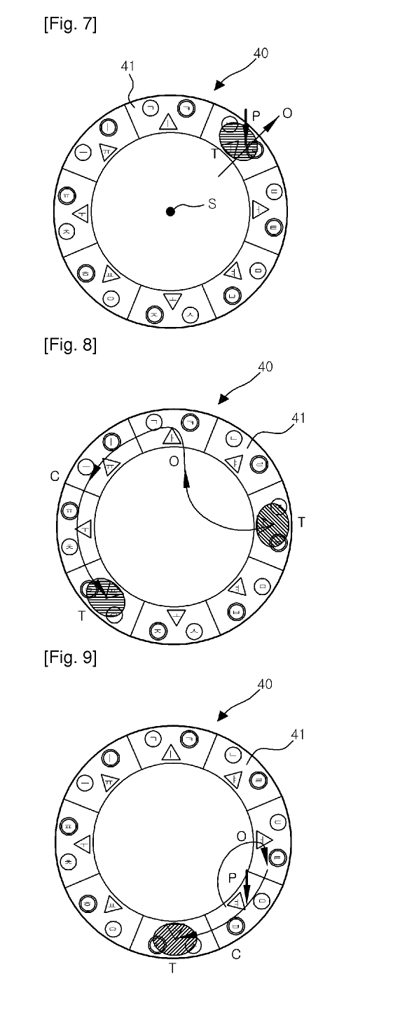

FIG. 7 is a diagram showing the construction of a second embodiment of a character inputting device according to the present invention, and FIGS. 8 and 9 are diagrams showing input actions in the second embodiment.

As shown in the drawings, in this embodiment, touch input T, pressing input P and outward touch movement input O may be performed on each of the input areas 41. First characters may be input by a touch, second characters may be input through pressing, and third characters may be input through outward touch movement.

In detail, in the input unit 40, [symbol] [symbol] [symbol] [symbol] [symbol] [symbol] [symbol] and [symbol] which are first consonants, are arranged as first characters and are selected by touching corresponding input areas 41. Further, [symbol] [symbol] [symbol] [symbol] [symbol] [symbol] [symbol] and [symbol] which are second consonants, are arranged as second characters and are selected by pressing corresponding input areas 41. Further, [symbol] [symbol] [symbol] [symbol] [symbol] [symbol] [symbol] and [symbol] which are second consonants, are arranged as third characters and are selected by performing outward touch movement on corresponding input areas 41. Here, although [symbol] and [symbol] are not consonants, they are included in the first characters and second characters, respectively, to bring the number of first characters and the number of second characters to 8.

Further, since the first characters can be input by a touch, an action indication unit 45 of ◯ indicating a touch is displayed together with each of the first characters. Since the second characters can be input through pressing an action indication unit 45 of ⊚ indicating pressing is displayed together with each of the second characters. Further, since the third characters can be input through outward touch movement, an action indication unit 45 of Δ pointing towards the outside of the input areas is displayed together with each of the third characters to indicate outward touch movement.

Next, in the present embodiment as shown in FIG. 7, the input of a character is described with reference to FIGS. 8 and 9.

For example, in order to input a character [symbol] touch input T is performed on an input area 41 located in the direction of 3 o'clock, as shown in FIG. 8. Then, a first character [symbol] displayed in the input area 41 located in the direction of 3 o'clock together with the action indication unit 45 indicating a touch, is input. Next, outward touch movement input O is performed on an input area 41 located in the direction of 12 o'clock. Then, a vowel [symbol] that is, a third character displayed in the input area 41 located in the direction of 12 o'clock together with the action indication unit 45 indicating outward touch movement, is input. Further, when touch input T is performed on an input area 41 located in the direction of 7 o'clock, a first character [symbol] displayed in the input area 41 located in the direction of 7 o'clock together with the action indication unit 45 indicating a touch, is input, and thus the character [symbol] is completed.

At this time, after the outward touch movement has been performed on the input area 41 located in the direction of 12 o'clock, circumferential touch movement input C of moving to the input area 41 located in the direction of 7 o'clock while moving in the circumferential direction is performed. Therefore, during the circumferential touch movement, input is not performed on intervening input areas 41, and thus a character assigned to the input action for the input area 41 which is located in the direction of 7 o'clock and is a final input location is input.

Further, in order to input a character [symbol] as shown in FIG. 9, pressing input P is performed on an input area 41 located in the direction of 5 o'clock. Then, a second character [symbol] displayed in the input area 41 located in the direction of 5 o'clock together with an action indication unit 45 indicating pressing, is input. Next, outward touch movement input O is performed on an input area 41 located in the direction of 3 o'clock. Then, a vowel [symbol] a third character, displayed in the input area 41 located in the direction of 3 o'clock together with an action indication unit 45 indicating outward touch movement, is input. Further, when touch input T is performed on an input area 41 located in the direction of 6 o'clock, a first character [symbol] displayed in the input area 41 located in the direction of 6 o'clock together with an action indication unit 45 indicating a touch, is input, and thus the character [symbol] is completed.

At this time, after the outward touch movement has been performed on the input area 41 located in the direction of 3 o'clock, circumferential touch movement input C of moving to the input area 41 located in the direction of 6 o'clock while moving in the circumferential direction is performed. Therefore, during the circumferential touch movement, input is not performed on intervening input areas 41, and thus a character, assigned to the input action for the input area 41 which is located in the direction of 6 o'clock and is a final input location, is input.

As described above, in the character inputting device 30 according to the present embodiment, characters can be input by manipulating the respective input areas 41 through a one action-one phoneme input (touch, pressing and outward touch movement). However, when these actions are implemented as one action, a one action-multi-phoneme input (touch+pressing+outward touch movement) is possible.

Further, in the character inputting device 30 according to the present embodiment, when two or more of touch input T, pressing input P, outward touch movement input O, and circumferential touch movement input C are continuously detected as one input, the control unit can process the input by recognizing that the respective characters have been input.

It is apparent that the scope of the present invention is not limited to the above embodiments and is defined by the accompanying claims, and various modifications and changes can be performed by those skilled in the art within the scope of the claims.

For example, it is possible to arrange four characters in each of the input areas 41 and to assign respective characters so that they can be input by a touch, pressing inward touch movement and outward touch movement.

Further, it is also possible to construct the character inputting device so that the input areas 41 can be indicated to be merely distinguishable from each other, and respective characters assigned thereto and the actions of inputting the characters are displayed on the display unit 20, thus enabling the user to input characters while monitoring the display unit 20.

Furthermore, it is possible to implement the input unit 40 on the display unit 20 when the display unit 20 is implemented as a touch screen.

1. A character inputting device, comprising: an input unit configured such that a plurality of input areas are radially arranged around a reference location and respectively spaced apart from each other independently, one or more characters are assigned to each input area, and the respective characters can be selected through different input actions including touching, pressing, outward touch movement, inward touch movement and circumferential touch movement; a detection unit configured to separately detect the different input actions for each of the input areas; and a control unit configured to extract a relevant character from a memory unit in accordance with results of the detection by the detection unit, and input the extracted character.

2. The character inputting device according to claim 1, wherein each input area is configured such that a first character, a second character and a third character are assigned thereto, the first character is selected by touching the input area, the second character is selected by performing the outward touch movement from the reference location towards an outside of the input area, and the third character is selected by performing the inward touch movement from the outside of the input area towards the reference location.

3. The character inputting device according to claim 1, wherein each input area is configured such that a first character, a second character and a third character are assigned thereto, the first character is selected by touching the input area, the second character is selected by pressing the input area, and the third character is selected by performing the outward touch movement from the reference location towards an outside of the input area.

4. The character inputting device according to claim 2, wherein one of the first character, the second character and the third character is a vowel.

5. The character inputting device according to claim 4, wherein the first character is a consonant, the second character is a vowel, and the third character is a consonant.

6. The character inputting device according to claim 4, wherein the first character is a first consonant, the second character is a second consonant, and the third character is a vowel.

7. The character inputting device according to claim 1, wherein the input unit is implemented as two units located on left and right sides so that they can be used by both hands.

8. The character inputting device according to claim 1, wherein the input unit is implemented as a ring-shaped integrated input unit.

9. The character inputting device according to claim 1, wherein the input unit is implemented as a touch pad or a touch screen.

10. The character inputting device according to claim 1, further comprising at least one input key which is capable of performing one or more functions and is provided inside or outside the input unit.

11. The character inputting device according to claim 1, wherein in each input area, characters which can be input are displayed, and action indication units required to distinguish respective input actions from each other are provided together with the displayed characters.

12. The character inputting device according to claim 1, wherein, when the input unit performs an input action of moving to a first input area in a circumferential direction and inputting a character assigned to the first input area, without terminating input for a second input area in a state in which the input for the second input area is performed, the control unit processes input by recognizing only the input for the second input area and the input for the first input area as effective inputs.

13. The character inputting device according to claim 12, wherein, when the detection unit detects that two or more input actions have been continuously performed in the input unit, the control unit processes input by recognizing that characters corresponding to the respective input actions are input for respective input areas on which the input actions are performed.

14. The character inputting device according to claim 3, wherein one of the first character, the second character and the third character is a vowel.

15. The character inputting device according to claim 2, wherein the input unit is implemented as two units located on left and right sides so that they can be used by both hands.

16. The character inputting device according to claim 2, wherein the input unit is implemented as a ring-shaped integrated input unit.

17. The character inputting device according to claim 2, wherein the input unit is implemented as a touch pad or a touch screen.

18. The character inputting device according to claim 2, further comprising at least one input key which is capable of performing one or more functions and is provided inside or outside the input unit.

19. The character inputting device according to claim 2, wherein in each input area, characters which can be input are displayed, and action indication units required to distinguish respective input actions from each other are provided together with the displayed characters.

20. The character inputting device according to claim 2, wherein, when the input unit performs an input action of moving to a first input area in a circumferential direction and inputting a character assigned to the first input area, without terminating input for a second input area in a state in which the input for the second input area is performed, the control unit processes input by recognizing only the input for the second input area and the input for the first input area as effective inputs.
